(19) United States
(12) Patent Application Publication
(10) Pub. No.: US 2025/0390116 A1
(43) Pub. Date: Dec. 25, 2025

(54) ANTICOLLISION MONITORING SYSTEM AND METHOD FOR AN AIRCRAFT TAKING PART IN A FORMATION FLIGHT

(71) Applicant: Airbus Operations (S.A.S.), Toulouse (FR)

(72) Inventors: Jean-Luc Robin, Toulouse (FR); Julio Hernanz Gonzalez, Toulouse (FR); Paulina Piatkowska, Toulouse (FR)

(21) Appl. No.: 19/239,187

(22) Filed: Jun. 16, 2025

(30) Foreign Application Priority Data
Jun. 24, 2024 (FR) 2406758

(51) Int. Cl. G05D 1/693; G05D 1/695; G05D 109/22

(52) U.S. Cl. CPC G05D 1/693; G05D 1/695; G05D 2109/22

(57) ABSTRACT

An anticollision monitoring system of a following aircraft includes electronic circuitry to store an initial power value of a radiofrequency signal received from a leading aircraft and to repeatedly carry out steps of receiving information relating to the power level of the radiofrequency signal received from the leading aircraft, storing a value of the power level, referred to as the current power level value; calculating a difference between the current power value and the initial power value, determining a first risk of collision between the following aircraft and the leading aircraft if the calculated difference is greater than a power threshold, and if the first collision risk is determined, ordering the issue of an alert in the cockpit of the following aircraft and ordering a disengagement of the participation of the following aircraft in the formation flight.

### TECHNICAL FIELD

The disclosure herein relates to the field of formation flying of aircraft. As is known, formation flying of a group of aircraft helps to reduce the fuel consumption of the group of aircraft. In a formation flight, an aircraft referred to as the following aircraft flies close to a vortex created by an aircraft which it follows, referred to as the leading aircraft. The different aircraft taking part in a formation flight thus fly close to one another. It is important to guarantee the safety of the different aircraft taking part in the formation flight by preventing any risk of collision between them. All transport aircraft are equipped with an anticollision system referred to as a TCAS (Traffic Collision Avoidance System). This system is provided to detect a risk of collision between aircraft and to control an avoidance maneuver when such a risk is detected.

### BACKGROUND

During a formation flight, given that the aircraft are flying close to one another, it would be useful to find a solution offering redundancy of the anticollision monitoring of the aircraft flying in formation.

As indicated above, the term “formation flight” is normally used to designate a predefined flight geometry according to which the aircraft fly close to one another. Under other circumstances, aircraft can fly according to a predefined geometry, for example when a following aircraft is intended to fly at a more or less constant distance from a leading aircraft, even if these aircraft do not fly close to one another. Given that the disclosure herein also monitors observance of such a more or less constant distance, the term “formation flight” in the description below includes the flight of the aircraft according to a predefined geometry.

### SUMMARY

The object of the disclosure herein is, in particular, to provide a solution to this problem. It relates to an anticollision monitoring system for a leading aircraft taking part in a formation flight in which the following aircraft flies close to a vortex created by a leading aircraft, the monitoring system comprising electronic circuitry integrated into at least one avionics computer of the aircraft, in which the electronic circuitry is configured to carry out the following steps:
receiving information relating to the activation of a formation flight guidance mode, from the following aircraft; and
receiving information identifying the leading aircraft.

The system is noteworthy in that the electronic circuitry is configured to:
receive information relating to the power level of a radiofrequency signal received from the leading aircraft by the following aircraft, the radiofrequency signal received by the following aircraft corresponding to a radiofrequency signal intended to be transmitted by the leading aircraft at a more or less constant power throughout a phase of the formation flight; and
storing a value of the power level, referred to as the initial power level, in response to receiving the information relating to the activation of the formation flight guidance mode of the following aircraft and the information identifying the leading aircraft,
and in that the electronic circuitry is further configured to carry out the following steps repeatedly during the participation of the following aircraft in the formation flight:
receiving information relating to the power level of the radiofrequency signal received from the leading aircraft by the following aircraft;
storing a value of the power level, referred to as the current power level, at a current time;
calculating a difference between the current power value and the initial power value;
determining a first risk of collision between the following aircraft and the leading aircraft if the calculated difference is greater than a power threshold; and
if the first collision risk is determined, ordering the issue of an alert in the cockpit of the following aircraft and ordering a disengagement of the participation of the following aircraft in the formation flight.

The anticollision warning system thus enables detection of an increase in the power level of the radiofrequency signal received from the leading aircraft, this increase in the power level corresponding to a decrease in a distance between the following aircraft and the leading aircraft. When this distance decreases sufficiently so that the increase in the power level reaches the power threshold, the monitoring system determines a risk of collision between the following aircraft and the leading aircraft and issues an alert in the cockpit. The anticollision monitoring system is thus redundant from the TCAS system since it permits the issue of an alert when the following aircraft comes too close to the leading aircraft.

According to different embodiments that can be taken in isolation or in combination:
the radiofrequency signal received by the following aircraft corresponds to a radiofrequency signal transmitted by a DME or ADS-B system of the leading aircraft;
the information relating to the power level of the radiofrequency signal received from the leading aircraft corresponds to a peak power level;
the power threshold is chosen within an interval [6 dB; 18 dB], preferably 12 dB;
the electronic circuitry is further configured to receive position information of the following aircraft originating from the receiver of a satellite positioning system of the following aircraft, as well as position information of the leading aircraft originating from a receiver of a satellite positioning system of the leading aircraft, in order to determine a distance between the following aircraft and the leading aircraft based on the position information of the following aircraft and the leading aircraft, and to determine a second risk of collision between the following aircraft and the leading aircraft when this distance is below a distance threshold. According to one embodiment, the electronic circuitry is configured to order the issue of an alert in the cockpit of the following aircraft and to order a disengagement of the participation of the following aircraft in the formation flight if the first collision risk or the second collision risk is determined. According to a different embodiment, the electronic circuitry is configured to order the issue of an alert in the cockpit of the following aircraft and to order a disengagement of the participation of the following aircraft in the formation flight if the first collision risk and the second collision risk are determined.

The disclosure herein also relates to an anticollision monitoring method for a following aircraft taking part in a formation flight in which the following aircraft flies close to a vortex created by a leading aircraft, the method comprising the following steps carried out by electronic circuitry integrated into at least one avionics computer of the aircraft;
receiving information relating to the activation of a formation flight guidance mode, from the following aircraft; and
receiving information identifying the leading aircraft.

The method is noteworthy in that it comprises the steps of:
receiving information relating to the power level of a radiofrequency signal received from the leading aircraft by the following aircraft, the radiofrequency signal received by the following aircraft corresponding to a radiofrequency signal intended to be transmitted by the leading aircraft at a more or less constant power throughout a phase of the formation flight; and
storing a value of the power level, referred to as the initial power level, in response to receiving the information relating to the activation of the formation flight guidance mode of the following aircraft and the information identifying the leading aircraft,
and in that it further comprises the following steps, carried out repeatedly during the participation of the following aircraft in the formation flight:
receiving information relating to the power level of the radiofrequency signal received from the leading aircraft by the following aircraft;
storing a value of the power level, referred to as the current power level, at a current time;
calculating a difference between the current power value and the initial power value;
determining a first risk of collision between the following aircraft and the leading aircraft if the calculated difference is greater than a power threshold;
and if the first collision risk is determined, ordering the issue of an alert in the cockpit of the following aircraft and ordering a disengagement of the participation of the following aircraft in the formation flight.

In one embodiment, the method further comprises the steps of receiving position information of the following aircraft originating from a receiver of a satellite positioning system of the following aircraft, as well as position information of the leading aircraft originating from a receiver of a satellite positioning system of the leading aircraft, determining a distance between the following aircraft and the leading aircraft based on the position information of the following aircraft and the leading aircraft, and determining a second risk of collision between the following aircraft and the leading aircraft when this distance is below a distance threshold.

The disclosure herein also relates to an aircraft comprising such an anticollision monitoring system.

### BRIEF DESCRIPTION OF THE DRAWINGS

The disclosure herein will be better understood from a reading of the following description, with reference to the attached figures.

FIG. 1 is a view of an aircraft comprising an anticollision monitoring system according to one embodiment of the disclosure herein.

FIG. 2 shows schematically an anticollision monitoring system of a following aircraft according to one embodiment of the disclosure herein.

FIG. 3A shows a first situation of a following aircraft in relation to a leading aircraft.

FIG. 3B shows a second situation of a following aircraft in relation to a leading aircraft

FIG. 3C shows a third situation of a following aircraft in relation to a leading aircraft.

FIG. 4 shows an anticollision monitoring system of a following aircraft, according to one embodiment of the disclosure herein.

### DETAILED DESCRIPTION

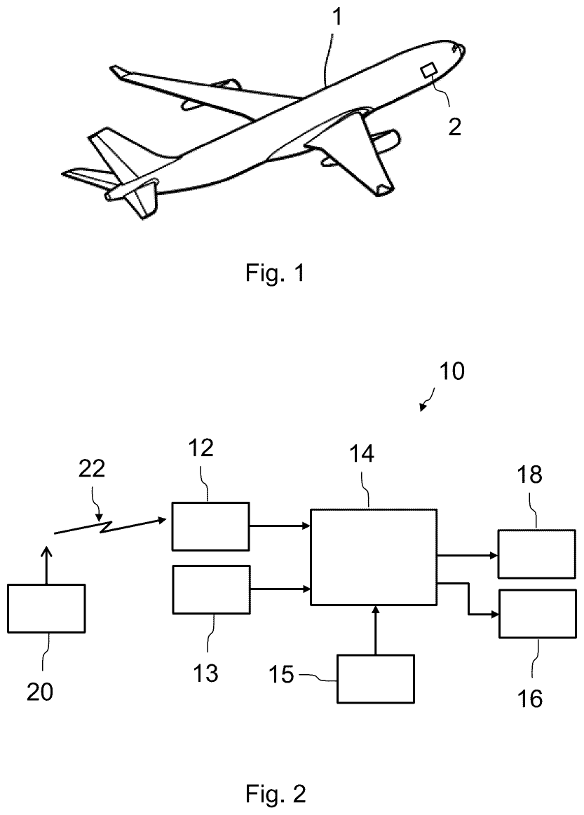

The anticollision monitoring system 10 shown in FIG. 2 is installed on-board an aircraft such as the aircraft 1 shown in FIG. 1. This anticollision monitoring system comprises electronic circuitry 14 integrated into at least one avionics computer, for example an avionics computer installed in an avionics bay 2 of the aircraft 1. The electronic circuitry 14 is connected at the input to a radiofrequency receiver 12 of the aircraft. More precisely, the radiofrequency receiver 12 is configured to determine and transmit information relating to the power level of a radiofrequency signal 22 received from a radiofrequency transmitter 20 of a leading aircraft when the leading aircraft 1 takes part in a formation flight as a following aircraft of the leading aircraft. The radiofrequency signal 22 concerned corresponds to a radiofrequency signal intended to be transmitted by the leading aircraft at a more or less constant power throughout a phase of the formation flight. Such a radiofrequency signal corresponds, for example, to a radiofrequency signal of a DME (“distance measuring equipment”) or ADS-B (“Automatic Dependent Surveillance-Broadcast”) system. The electronic circuitry 14 is also connected at the input to an information source 13 configured to determine and transmit information identifying a leading aircraft when the aircraft 1 takes part, as a following aircraft, in a formation flight. The electronic circuitry 14 is also connected at the input to an information source 15 configured to determine and transmit information relating to the activation of a formation flight guidance mode, of the aircraft 1 as the following aircraft. The electronic circuitry 14 is connected at the output to the display system 18 in the cockpit of the aircraft 1, and to a guidance system 16 of the aircraft 1.

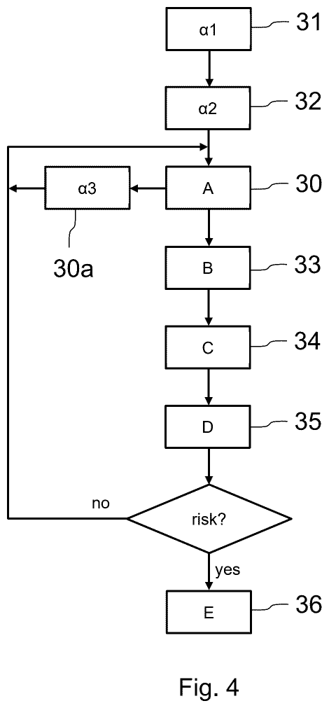

During the initialization of a formation flight, the different aircraft taking part in this formation flight position themselves relative to one another according to a geometry such that the following aircraft flies close to a vortex created by a leading aircraft. The distances between the aircraft are chosen to guarantee the safety of the flight of the different aircraft taking part in the formation flight. In the description below, it is assumed that the aircraft 1 takes part in the formation flight as the following aircraft of a leading aircraft. When the different aircraft taking part in the formation flight are correctly positioned according to this geometry, a formation flight guidance mode is activated for at least some of the aircraft taking part in the formation flight as following aircraft, including at least the aircraft 1 concerned. According to a first alternative, the activation of the formation flight guidance mode is implemented automatically by a formation flight management system including at least one avionics computer installed on-board the aircraft 1. In particular, the information source 15 configured to determine and transmit the information relating to the activation of a formation flight guidance mode then corresponds to this avionics computer. According to a second alternative, the activation of the formation flight guidance mode is implemented manually by a pilot of the aircraft by a man-machine interface in the cockpit of the aircraft. In particular, the information source 15 configured to determine and transmit the information relating to the activation of a formation flight guidance mode then corresponds to this man-machine interface or to a computer connected to this man-machine interface. The reception by the processing unit 14 of the information relating to the activation of a formation flight guidance mode corresponds to a step 31, denoted α1, of the method shown in FIG. 4.

At the latest at the time of initialization of the formation flight, the identity of the leading aircraft that will be followed by the aircraft 1 as the following aircraft is known on-board the aircraft 1. According to a first alternative, the formation flight is managed automatically by a formation flight management system comprising at least one avionics computer installed on-board the aircraft 1, and the information source 13 configured to determine and transmit the information identifying the leading aircraft then corresponds to this avionics computer. According to a second alternative, the identity of the leading aircraft is known to a pilot of the aircraft 1 and it is captured manually by this pilot by a man-machine interface in the cockpit of the aircraft. In particular, the information source 13 configured to determine and transmit the information identifying the leading aircraft then corresponds to this man-machine interface or to a computer connected to this man-machine interface. The reception by the processing unit 14 of the information identifying the leading aircraft corresponds to a step 32, denoted α2, of the method shown in FIG. 4.

The radiofrequency receiver 12 receives radiofrequency signals 22 from the radiofrequency transmitter 20 of the leading aircraft repeatedly during the formation flight, or even during the initialization of the formation flight, in a step 30 of the method, denoted A in FIG. 4. The radiofrequency receiver 22 determines information relating to the power level of the radiofrequency signals 22, in particular information relating to the peak power level, and transmits this information to the electronic circuitry 14. Following the initialization of the formation flight, in response to receiving the information identifying the leading aircraft, from the information source 13, and also the reception of the information relating to the activation of the formation flight guidance mode, from the information source 15, the processing unit 14 stores a power level value received from the radiofrequency receiver 12. In the description below this stored power level value is referred to as the initial power value.

According to a first alternative, immediately after having received the information identifying the leading aircraft, from the information source 13, and also the information relating to the activation of the formation flight guidance mode, from the information source 15, the processing unit 14 stores a current value of the power level received from the radiofrequency receiver 12. In the description below, this stored power level value is referred to as the initial power value.

According to a second alternative, particularly if the processing unit 14 had not yet received any power level information, originating from the radiofrequency receiver 12, on receiving the information identifying the leading aircraft and the information relating to the activation of the formation flight guidance mode, the processing unit stores, as the initial power value, the first power level information which it receives from the radiofrequency receiver 12 following the reception of the information identifying the leading aircraft and the information relating to the activation of the formation flight guidance mode.

According to a third alternative, the processing unit stores, as the initial power value, an average of the first power level information elements which it receives from the radiofrequency receiver 12 during a time interval after (or before) receiving the information identifying the leading aircraft and the information relating to the activation of the formation flight guidance mode. In particular, the duration of the time interval is chosen as a maximum of 2 minutes, preferably a maximum of 30 seconds. The storage of the initial power value by the processing unit 14 corresponds to a step 30a, denoted α3, of the method shown in FIG. 4.

During the participation of the aircraft 1 in the formation flight, the processing unit 14 repeatedly implements the following steps, as shown in FIG. 4:
a step 33, denoted B in FIG. 4, of storing a power level value received from the radiofrequency receiver 12, referred to as the current power value. In particular, this power level value corresponds, at a current time, to the last power level value received from the radiofrequency receiver 12, or to an average of the last power level values received from the radiofrequency receiver 12 during a time interval lasting, for example, a maximum of 1 minute, preferably a maximum of 30 seconds;
a step 34, denoted C in the figure, of calculating a difference between the current power value and the initial power value;
a step 35, denoted D in the figure, of determining a first risk of collision between the aircraft 1 and the leading aircraft if the difference calculated in step 34 is greater than a power threshold.

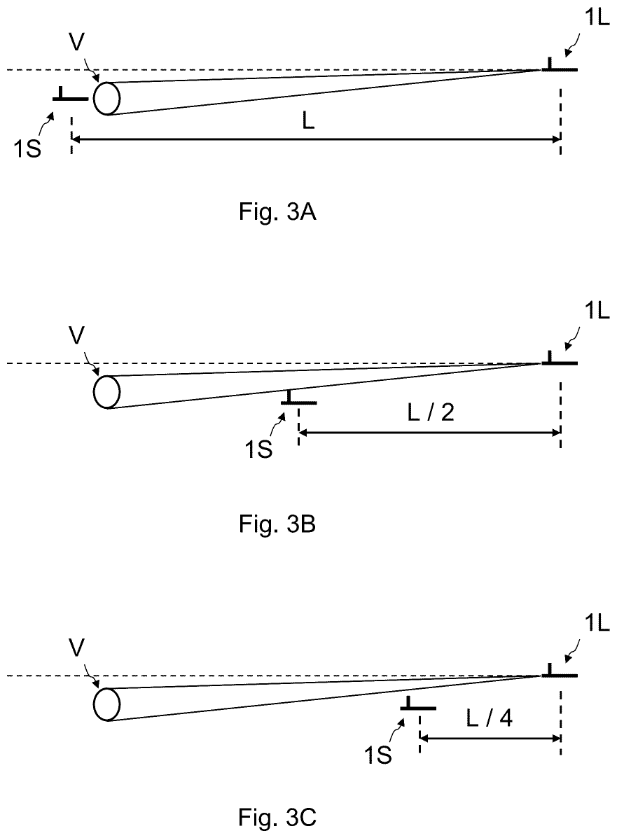

When it is positive, the difference calculated in step 34 corresponds to an increase in the power level of the radiofrequency signal 22 received by the radiofrequency receiver 12, between the time of storage of the initial power value and the current time. Given that the radiofrequency signal 22 is transmitted by the leading aircraft at a more or less constant power, an increase, between these two times, in the power level received by the radiofrequency receiver 12 corresponds to a reduction in the distance between the leading aircraft and the following aircraft 1. This is shown in FIGS. 3A, 3B and 3C. In FIG. 3A, a following aircraft 1S flies close to a vortex V created by a leading aircraft 1L. These two aircraft are separated by a distance L. This situation corresponds, for example, to a nominal positioning of the aircraft, such as on initialization of the formation flight. The power level of the radiofrequency signal 22 corresponds to the initial power value. In the situation shown in FIG. 3B, the aircraft 1S and 1L have drawn near to one another and the distance separating them is now only a half (L/2) of the distance L. According to the laws of physics, the level of the radio frequency signal received by the radiofrequency receiver 12 of the following aircraft 1S is inversely proportional to the square of the distance between the two aircraft. Consequently, the current power value is then +6 dB (dB) higher than the initial power value. In the situation shown in FIG. 3C, the aircraft 1S and 1L have again drawn near to one another and the distance separating them is now only a quarter (L/4) of the distance L. Consequently, the current power value is then +12 dB (decibels) higher than the initial power value.

Consequently, the power threshold considered in step 35 corresponds to a reduction in the distance separating the following aircraft 1S from the leading aircraft 1L between the initialization of the formation flight and a current time. This threshold is chosen such that the corresponding distance between the following aircraft and the leading aircraft guarantees the safety of the flight of the aircraft without risk of collision. In one exemplary embodiment, it is chosen within an interval [+6 dB; +18 dB], preferably +12 dB, corresponding to the situation shown in FIG. 3C.

In the absence of a collision risk, the method is repeated from step 30. If a collision risk is determined in step 35, the processing unit sends a signal to the display system 18 during a step 36, denoted E in FIG. 4, to order the issue of an alert in the cockpit of the following aircraft 1. This alert can be either visual or audible. Furthermore, the processing unit 14 sends a signal to the guidance system 16 to order a disengagement of the participation of the following aircraft in the formation flight: shutdown of the formation flight guidance mode. The following aircraft 1 is then controlled, either manually or automatically, to distance itself from the other aircraft taking part in the formation flight, so as to avoid any collision risk.

In an embodiment, the electronic circuitry 14 is further configured to receive position information of the following aircraft from a receiver of a satellite positioning system of the following aircraft, in particular from an MMR (“Multi-Mode Receiver”), and position information of the leading aircraft from a receiver of a satellite positioning system of the leading aircraft, in order to determine a distance between the following aircraft and the leading aircraft based on the position information of the following aircraft and the leading aircraft, and to determine a second risk of collision between the following aircraft and the leading aircraft when this distance is less than a distance threshold. The position information of the leading aircraft is, for example, transmitted from the leading aircraft to the following aircraft by an ADS-B system. The determination of the second risk is thus redundant from the determination of the first risk in step 35.

According to a first variant, the processing unit 14 combines the first risk and the second risk according to a logical AND to order the issue of an alert in the cockpit of the following aircraft and to order a disengagement of the participation of the following aircraft in the formation flight. The redundancy according to this first variant guarantees that the issue of the alert and the disengagement from the participation of the following aircraft in the formation flight are ordered only if the determination of the first risk is confirmed by the determination of the second risk.

According to a second variant, the processing unit 14 combines the first risk and the second risk according to a logical OR to order the issue of an alert in the cockpit of the following aircraft and to order a disengagement of the participation of the following aircraft in the formation flight. The redundancy according to this second variant guarantees that the issue of the alert and the disengagement from the participation of the following aircraft in the formation flight are ordered even in the event of failure in the determination of one of the first risk or the second risk.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An anticollision monitoring system for a leading aircraft taking part in a formation flight in which a following aircraft flies close to a vortex created by a leading aircraft, the monitoring system comprising electronic circuitry integrated into at least one avionics computer of the aircraft, wherein the electronic circuitry is configured to:
receive information relating to activation of a formation flight guidance mode, from the following aircraft; and
receive information identifying the leading aircraft;
wherein the electronic circuitry is configured to:
receive information relating to a power level of a radiofrequency signal received from the leading aircraft by the following aircraft, the radiofrequency signal received by the following aircraft corresponding to a radiofrequency signal to be transmitted by the leading aircraft at a more or less constant power throughout a phase of the formation flight; and
store a value of the power level, referred to as an initial power level value, in response to receiving the information relating to the activation of the formation flight guidance mode of the following aircraft and the information identifying the leading aircraft;
wherein the electronic circuitry is further configured to carry out, repeatedly during participation of the following aircraft in the formation flight, steps of:
receiving information relating to the power level of the radiofrequency signal received from the leading aircraft by the following aircraft;
storing a value of the power level, referred to as a current power level, at a current time;
calculating a difference between the current power level value and the initial power level value;
determining a first collision risk between the following aircraft and the leading aircraft if the calculated difference is greater than a power threshold; and
if the first collision risk is determined, ordering issue of an alert in a cockpit of the following aircraft and ordering a disengagement of the participation of the following aircraft in the formation flight.

2. The system of 1, wherein the radiofrequency signal received by the following aircraft corresponds to a radiofrequency signal transmitted by a DME or ADS-B system of the leading aircraft.

3. The system of claim 1, wherein the information relating to the power level of the radiofrequency signal received from the leading aircraft corresponds to a peak power level.

4. The system of claim 1, wherein the power threshold is within an interval [6 dB; 18 dB], or is 12 dB.

5. The system of claim 1, wherein the electronic circuitry is further configured to receive position information of the following aircraft originating from a receiver of a satellite positioning system of the following aircraft, as well as position information of the leading aircraft originating from a receiver of a satellite positioning system of the leading aircraft, in order to determine a distance between the following aircraft and the leading aircraft based on the position information of the following aircraft and the leading aircraft, and to determine a second collision risk between the following aircraft and the leading aircraft when the distance is below a distance threshold.

6. The system of 5, wherein the electronic circuitry is configured to order issue of an alert in the cockpit of the following aircraft and to order a disengagement of the participation of the following aircraft in the formation flight if the first collision risk or the second collision risk is determined.

7. The system of 5, wherein the electronic circuitry is configured to order issue of an alert in the cockpit of the following aircraft and to order a disengagement of the participation of the following aircraft in the formation flight if the first collision risk and the second collision risk are determined.

8. An anticollision monitoring method for a following aircraft taking part in a formation flight in which the following aircraft flies close to a vortex created by a leading aircraft, the method comprising steps, carried out by electronic circuitry integrated into at least one avionics computer of the aircraft, of:
receiving information relating to activation of a formation flight guidance mode, from the following aircraft; and
receiving information identifying the leading aircraft;
wherein the method comprises:
receiving information relating to a power level of a radiofrequency signal received from the leading aircraft by the following aircraft, the radiofrequency signal received by the following aircraft corresponding to a radiofrequency signal to be transmitted by the leading aircraft at a more or less constant power throughout a phase of the formation flight; and
storing a value of the power level, referred to as an initial power level value, in response to receiving the information relating to the activation of the formation flight guidance mode of the following aircraft and the information identifying the leading aircraft;
and further comprising steps, carried out repeatedly during participation of the following aircraft in the formation flight, of:
receiving information relating to the power level of the radiofrequency signal received from the leading aircraft by the following aircraft;
storing a value of the power level, referred to as a current power level value, at a current time;
calculating a difference between the current power level value and the initial power level value;
determining a first risk of collision between the following aircraft and the leading aircraft if the calculated difference is greater than a power threshold; and
if the first collision risk is determined, ordering issue of an alert in a cockpit of the following aircraft and ordering a disengagement of the participation of the following aircraft in the formation flight.

9. The method of claim 8, further comprising steps of receiving position information of the following aircraft originating from a receiver of a satellite positioning system of the following aircraft, as well as position information of the leading aircraft originating from a receiver of a satellite positioning system of the leading aircraft, determining a distance between the following aircraft and the leading aircraft based on the position information of the following aircraft and the leading aircraft, and determining a second risk of collision between the following aircraft and the leading aircraft when the distance is below a distance threshold.

10. An aircraft comprising the anticollision monitoring system of claim 1.
